(19) United States
(12) Patent Application Publication
(10) Pub. No.: US 2014/0327183 A1
(43) Pub. Date: Nov. 6, 2014

(54) IMPRINT METHOD AND IMPRINT APPARATUS

(71) Applicant: CANON KABUSHIKI KAISHA, Tokyo (JP)

(72) Inventors: Sunao Mori, Utsunomiya-shi (JP); Keiji Yamashita, Utsunomiya-shi (JP); Keita Sakai, Utsunomiya-shi (JP)

(21) Appl. No.: 14/333,226

(22) Filed: Jul. 16, 2014

Related U.S. Application Data
(63) Continuation of application No. PCT/JP2014/050500, filed on Jan. 15, 2014.

(30) Foreign Application Priority Data
Jan. 17, 2013 (JP) 2013-006316

(51) Int. Cl. B29C 59/02

(52) U.S. Cl. CPC B29C 59/026
USPC 264/293; 425/385

(57) ABSTRACT

An object is to provide an imprint method or an imprint apparatus that not only reduces the time for filling with resin or reduces pattern defects, but also reduces the surface roughness of resin. An imprint method brings a resin on a substrate and a mold having a pattern into contact with each other to transfer the pattern onto the substrate. The imprint method includes a step of bringing the resin on the substrate and the mold into contact with each other while a space between the substrate and the mold is filled with a predetermined gas, a step of curing the resin while the resin and the mold are in contact with each other, and a step of separating the resin and the mold. The predetermined gas contains a first gas having a solubility of 0.36 mol/liter or more in the resin and a second gas having a solubility of less than 0.36 mol/liter in the resin, at 20° C. and a pressure of 1 atmosphere.

### CROSS-REFERENCE TO RELATED APPLICATIONS

This application is a Continuation of International Patent Application No. PCT/JP2014/050500, filed Jan. 15, 2014, which claims the benefit of Japanese Patent Application No. 2013-006316, filed Jan. 17, 2013, both of which are hereby incorporated by reference herein in their entirety.

### TECHNICAL FIELD

The present invention relates to an imprint method and an imprint apparatus.

### BACKGROUND ART

An imprint method is known as a lithography technique for manufacturing devices (semiconductor integrated circuit devices, liquid crystal display devices, etc.). This is a method that brings a resin on a substrate, such as a wafer or glass plate, and a mold having a fine pattern into contact with each other, cures the resin while the resin and the mold are in contact with each other, and thus transfers the pattern onto the substrate.

In such an imprint method, it is required not only to reduce the time for filling recessed portions of a pattern with resin (filling time) for improved productivity, but also to reduce pattern defects for improved yield.

In particular, when the resin and the mold are brought into contact with each other in the atmosphere, the filling time is longer because a gas tends to remain between the resin and the mold.

Patent Literature (PTL) 1 discloses a technique in which, to reduce the filling time, a resin and a mold are brought into contact with each other after helium or carbon dioxide is supplied between the resin and the mold. These gasses are known to contribute to reduced filling time.

PTL 2 discloses a technique in which, for the same purpose as above, a resin and a mold are brought into contact with each other after a condensable gas is supplied.

Non Patent Literatures (NPLs) 1 and 2 disclose techniques in which 1,1,1,3,3-pentafluoropropane (pentafluoropropane), which is a condensable gas, is supplied between a resin and a mold. These non-patent literatures state that supplying pentafluoropropane can lower the viscosity of the resin before curing, and can reduce release force that separates the mold and the resin after curing.

### CITATION LIST

### Patent Literature

PTL 1: PCT Japanese Translation Patent Publication

PTL 2: Japanese Patent Laid-Open No. 2004-103817 Non Patent Literature

NPL 1: Hiroshima, Journal of Vacuum Science and Technology B 27(6) (2009) 2862-2865

NPL 2: Hiroshima, Journal of Photopolymer Science and Technology Volume 23, Number 1 (2010) 45-50

As described above, supplying pentafluoropropane can lower the viscosity of resin to reduce the filling time, and can reduce release force to reduce pattern defects.

Studies done by the inventors of the present application have shown that pentafluoropropane is a gas which is soluble in resin, and that this property produces the functional effects described above.

At the same time, the inventors have found a problem in which the surface roughness of cured resin in the case of supplying such a gas is greater than that in the case of supplying no gas. This is probably because a gas dissolved in the resin volatilizes from the resin surface after separation of the resin and the mold.

In a lithography technique, for example, a pattern with a line width of 20 nm to 100 nm is transferred, and it is required to transfer a finer pattern. Therefore, even if an increase in surface roughness is as small as several nanometers, the device performance may be degraded or the yield may be lowered by the presence of defectives.

The invention of the present application has been made to solve the problems described above. An object of the invention is to provide an imprint method or an imprint apparatus that not only reduces the time for filling with resin or reduces pattern defects, but also reduces the surface roughness of resin.

### SUMMARY OF INVENTION

An imprint method according to the present invention brings a resin on a substrate and a mold having a pattern into contact with each other to transfer the pattern onto the substrate. The imprint method includes a step of bringing the resin on the substrate and the mold into contact with each other while a space between the substrate and the mold is filled with a predetermined gas, a step of curing the resin while the resin and the mold are in contact with each other, and a step of separating the resin and the mold. The predetermined gas contains a first gas having a solubility of 0.36 mol/liter or more in the resin and a second gas having a solubility of less than 0.36 mol/liter in the resin, at 20° C. and a pressure of 1 atmosphere.

An imprint apparatus according to the present invention brings a resin on a substrate and a mold having a pattern into contact with each other to transfer the pattern onto the substrate. The imprint apparatus includes a gas supply unit configured to supply a predetermined gas to the resin on the substrate, a driving mechanism configured to bring the resin on the substrate and the mold into contact with each other, and curing means for curing the resin while the resin and the mold are in contact with each other. The predetermined gas contains a first gas having a solubility of 0.36 mol/liter or more in the resin and a second gas having a solubility of less than 0.36 mol/liter in the resin, at 20° C. and a pressure of 1 atmosphere.

Further features of the present invention will become apparent from the following description of exemplary embodiments with reference to the attached drawings.

### BRIEF DESCRIPTION OF DRAWINGS

FIG. 1 is a schematic view of an imprint apparatus to which the present invention is applied.

FIG. 2A is a schematic view of a gas supply unit.

FIG. 2B illustrates the gas supply unit as viewed from a substrate side.

FIG. 3 is a graph showing a relationship between a release force and a surface roughness for each gas concentration.

FIG. 4 is a flowchart of an imprint method to which the present invention is applied.

FIG. 5 illustrates an example in which a mold is provided with a gas supply port.

FIG. 6 illustrates an example in which a mold chuck is surrounded by a gas supply port.

### DESCRIPTION OF EMBODIMENTS

Preferred embodiments of the present invention will now be described in detail with reference to the attached drawings.

### First Embodiment

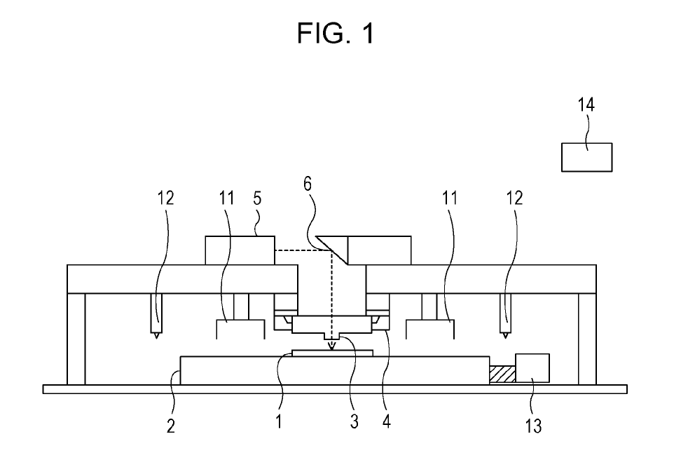

FIG. 1 illustrates an imprint apparatus according to a first embodiment.

The imprint apparatus brings a resin on a substrate 1 and a mold 3 having a fine pattern into contact with each other, cures the resin while the resin and the mold 3 are in contact with each other, and thus transfers the pattern onto the substrate 1. Such an imprint apparatus is used, for example, to manufacture devices (semiconductor integrated circuit devices, liquid crystal display devices, etc.). For example, a silicon wafer or a glass plate is used as the substrate 1.

There are two types of known imprint apparatuses. One is a type of imprint apparatus that uses a mold having a pattern of substantially the same size as a substrate to transfer the entire pattern at once. The other is a type of imprint apparatus that uses a mold having a pattern smaller than a substrate to transfer the pattern multiple times. Although the present embodiment describes an example of the latter type (so called step and repeat type), the present invention is not limited to this. In the latter type, a region on the substrate, the region corresponding to a single transfer step, is referred to as a “shot region”.

In FIG. 1, a direction perpendicular to a pattern of the mold 3 is defined as a Z-axis, and two axes orthogonal to the Z-axis are defined as an X-axis and a Y-axis. Typically, the Z-axis is parallel to a vertical direction.

The imprint apparatus includes a light source (curing means) 5 that emits light used for curing, a mold chuck (mold retainer) 4 for retaining the mold 3, and a substrate chuck (substrate retainer) 2 for retaining the substrate 1. The imprint apparatus further includes dispensers (applying units) 12 for applying a resin to the substrate 1, and gas supply units 11 that supply a predetermined gas to a space between the mold 3 and the substrate 1.

Although two dispensers 12 and two gas supply units 11 are provided in the present embodiment, the present invention is not limited to this, and one dispenser 12 and one gas supply unit 11 may be provided.

For example, ultraviolet light is used as light for curing, but the wavelength of light is not limited to this. The imprint apparatus includes an optical system that guides light from the light source 5 to the mold 3. FIG. 1 illustrates a mirror 6 which is part of the optical system.

The mold 3 is configured to be capable of transmitting light from the light source 5. For example, the mold 3 is formed of quartz, silicon, resin, or a material containing a mixture of these materials. In the present embodiment, the mold 3 has a protruding portion, whose surface is provided with a micro-asperity pattern (pattern portion).

The imprint apparatus further includes a driving mechanism 13 for adjusting a relative position of the mold chuck 4 and the substrate chuck 2.

The driving mechanism 13 is used not only to bring the mold 3 and a resin on the substrate 1 into contact with each other, but also to separate them. The driving mechanism 13 moves at least one of the mold chuck 4 and the substrate chuck 2 along the Z-axis. In the present embodiment, the driving mechanism 13 moves only the mold chuck 4 along the Z-axis to bring the mold 3 and the resin into contact with each other.

The driving mechanism 13 is also used to adjust a relative position of the mold 3 and the substrate 1 in directions along the X-axis and the Y-axis. The driving mechanism 13 moves at least one of the mold chuck 4 and the substrate chuck 2 along the X-axis and the Y-axis. In the present embodiment, the driving mechanism 13 moves only the substrate chuck 2 along the X-axis and the Y-axis.

The driving mechanism 13 is also used to adjust a relative position of the dispensers 12 and the substrate 1 in the directions along the X-axis and the Y-axis. The driving mechanism 13 moves at least the dispensers 12 or the substrate chuck 2 along the X-axis and the Y-axis. In the present embodiment, the driving mechanism 13 moves only the substrate chuck 2 along the X-axis and the Y-axis.

For example, a linear motor is preferably used as the driving mechanism 13. FIG. 1 is merely a schematic view, and the location and stroke of the driving mechanism 13 may be designed appropriately.

The imprint apparatus further includes a control unit 14 that includes a CPU and a memory. The control unit 14 controls sequences of the imprint apparatus, controls the driving mechanism 13, and controls the dispensers 12. Although only one control unit is shown in the drawing, there may be a plurality of control units depending on the type of control object.

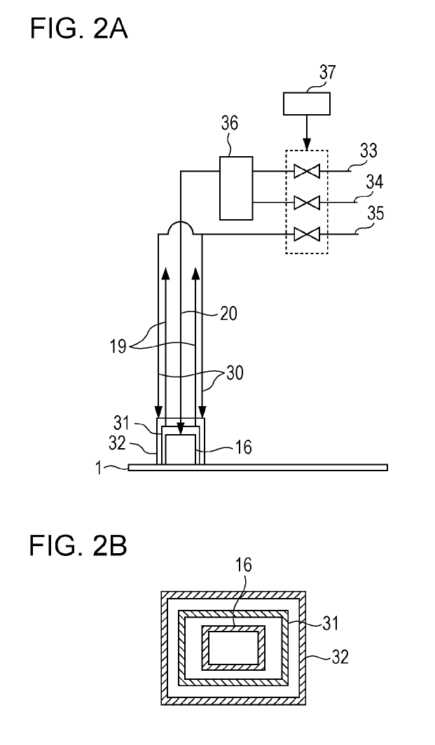

FIGS. 2A and 2B illustrate details of one gas supply unit 11.

The gas supply unit 11 is used to fill a space between the substrate 1 and the mold 3 with a predetermined gas.

The gas supply unit 11 includes a readily-soluble gas supply line 33 (readily-soluble gas supply portion), a slightly-soluble gas supply line 34 (slightly-soluble gas supply portion), and a gas mixture supply line 20 for supplying a gas mixture composed of a readily-soluble gas and a slightly-soluble gas.

The readily-soluble gas supply line 33 and the slightly-soluble gas supply line 34 are each provided with a regulating valve for regulating the flow rate. A flow control unit 37 controls the regulating valve to regulate the concentration of each gas contained in the gas mixture. A temperature control unit 36 is capable of regulating the temperature of the gas mixture. Since each unit is typically disposed in a chamber controlled at a temperature of about 20° C., the temperature control unit 36 is adjusted to a temperature of about 20° C.

The gas supply unit 11 further includes an inert gas supply line 35 for supplying an inert gas, and discharge lines 20 for discharging a gas. The inert gas supply line 35 is provided with a regulating valve for regulating the flow rate.

The gas supply unit 11 has a supply port (first supply port) 16, a discharge port 31, and a supply port (second supply port) 32.

FIG. 2B illustrates these supply ports and the discharge port as viewed from the substrate 1. As illustrated, the supply ports and the discharge port are each defined by one or more division walls. The supply port 16, the discharge port 31, and the supply port 32 are arranged in this order from the inside. The supply port 16 is surrounded by the discharge port 31, which is surrounded by the supply port 32.

The supply port 16 is connected to the gas mixture supply line 20, the supply port 32 is connected to the inert gas supply line 35, and the discharge port 31 is connected to the discharge lines 19.

The configuration of the gas supply unit 11 is not limited to this. For example, the discharge port 31 and the discharge lines 19 are provided to reduce leakage of gas from the supply port 16 to an area around the substrate chuck 2. The discharge port 31 and the discharge lines 19 are not necessary when there is no need to reduce such leakage of gas to the surrounding area.

In a lithography apparatus which transfers, for example, a pattern with a line width of 20 nm to 100 nm, it is necessary to adjust the position of the substrate chuck 2 with high precision. Typically, a position measuring means, such as a laser interferometer, is used to adjust the position of the substrate chuck 2. The leakage of gas described above causes fluctuations in refractive index in a light path of measurement light of the laser interferometer, and thus may deteriorate the positioning precision. With a discharge port, it is possible to improve the positioning precision.

The inert gas supply line 35 and supply port 32 are also used to reduce fluctuations in refractive index. A gas supplied from the supply port 32 is discharged via the discharge port 31. Thus, a gas supplied from the supply port 16 is sealed.

Although a gas mixture of a readily-soluble gas and a slightly-soluble gas is supplied in the present embodiment, the readily-soluble gas and the slightly-soluble gas may be supplied from independent supply ports. A “gas supply unit configured to supply a predetermined gas (gas mixture)” includes such a configuration. The gas supply unit 11 is disposed between the mold chuck 4 and the dispensers 12 in the XY-plane. By moving the substrate chuck 2 while supplying a gas mixture from the gas supply unit 11, the gas mixture can be supplied to a space between the mold 3 and the substrate 1.

That is, the “gas supply unit configured to supply a predetermined gas (gas mixture) to a space between the mold 3 and the substrate 1” includes a configuration in which a gas mixture is supplied to a resin on the substrate 1 and then the substrate 1 is moved to a position below the mold 3.

An imprint method of the present embodiment will now be described.

The substrate 1 introduced into the imprint apparatus is mounted on the substrate chuck 2 by conveying means (not shown), and subjected to positioning by a position detecting system (not shown). Sequences for conveying and positioning the substrate 1 will not be described here, because a publicly known technique is applicable.

In step S110, the driving mechanism adjusts the position of the substrate 1 in the directions along the X-axis and the Y-axis such that a shot region on the substrate 1 to which a pattern is to be transferred faces a discharge portion of a dispenser 12.

In step S120, the dispenser 12 applies a resin to the shot region on the substrate 1 to which the pattern is to be transferred.

In step S130, a gas supply unit 11 supplies a gas mixture to a space between the substrate 1 and the mold 3. The gas mixture contains a readily-soluble gas (first gas) having a solubility of 0.36 mol/liter (L) or more in the resin and a slightly-soluble gas (second gas) having a solubility of less than 0.36 mol/L in the resin at 20° C. and a pressure of 1 atmosphere. The details of the readily-soluble gas and the slightly-soluble gas will be described later on.

The gas mixture may start to be supplied before step S120.

In step S140, the driving mechanism adjusts the position of the substrate 1 in the directions along the X-axis and the Y-axis such that the shot region on the substrate 1 to which the pattern is to be transferred faces the pattern portion of the mold 3.

By moving the substrate chuck 2 while supplying the gas mixture from the gas supply unit 11, the space between the mold 3 and the substrate 1 can be filled with the gas mixture. By supplying the gas mixture in parallel with the movement of the substrate chuck 2, the gas mixture is drawn into the space between the pattern portion of the mold 3 and the shot region on the substrate 1, so that the space between them can be efficiently filled with the gas mixture. Note that a state of being “filled with a gas mixture” does not exclude a state in which a small amount of gas other than the gas mixture is present.

In step S150, the driving mechanism brings the resin and the mold 3 into contact with each other while the space between the substrate 1 and the mold 3 is filled with the gas mixture.

In step S160, the resin is cured while the resin and the mold 3 are in contact with each other. Specifically, the light source 5 irradiates the resin with light via the mold 3.

In step S170, the driving mechanism separates the resin and the mold 3.

By the steps described above, the pattern of the mold 3 is transferred to the shot region on the substrate 1.

If there is another shot region on the substrate to which the pattern is to be transferred, steps S110 to S170 are performed on this shot region.

The readily-soluble gas and the slightly-soluble gas will now be described.

In the present embodiment, a photo-curable acrylic resin is used as the resin, pentafluoropropane is used as the readily-soluble gas, and helium is used as the slightly-soluble gas.

The amount of pentafluoropropane dissolved in 1 mL of acrylic resin is about 600 mg, that is, 4.48 mol/L at 20° C. and a pressure of 1 atmosphere. The amount of helium dissolved in 1 mL of acrylic resin is about 0.002 mg, that is, 0.0005 mol/L at 20° C. and a pressure of 1 atmosphere.

Supplying pentafluoropropane can not only lower the viscosity of the resin before curing, but also reduce release force that separates the mold and the resin after curing. Since helium easily diffuses from the space between the resin and the mold to the area therearound, supplying helium can help reduce the filling time.

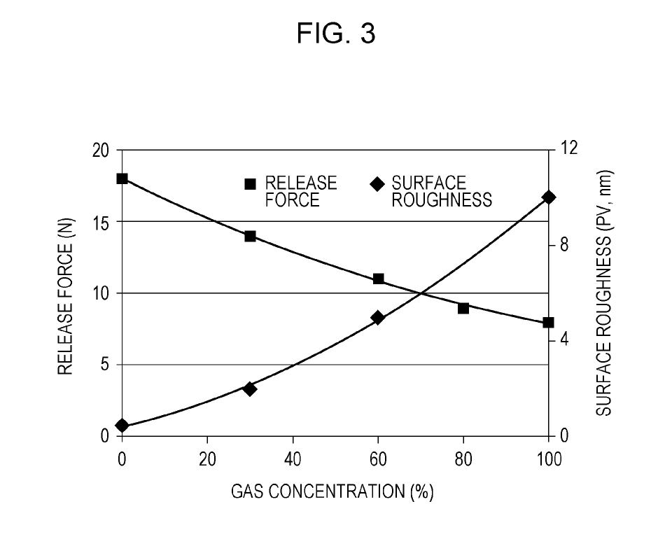

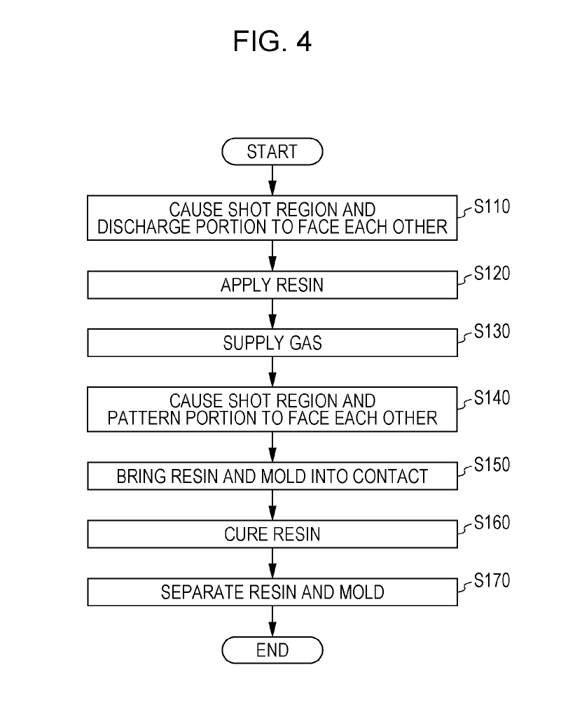

FIG. 3 shows a result of evaluation of a release force (in N) and a surface roughness of cured resin (PV value in nm) for each concentration of pentafluoropropane in the gas mixture. The release force is a force required to separate the mold and the cured resin. The release force can be measured by a load sensor in or near the substrate chuck 2. The surface roughness can be measured by observing the surface of the cured resin with a microscope (e.g., atomic force microscope).

FIG. 3 shows that the release force decreases and the surface roughness increases with increasing concentration of pentafluoropropane.

In a lithography technique, for example, a pattern with a line width of 20 nm to 100 nm is transferred, and it is required to transfer a finer pattern. Therefore, even if an increase in surface roughness is as small as several nanometers, the device performance may be degraded or the yield may be lowered by the presence of defectives.

For example, if an allowable surface roughness is 4 nm, the concentration of pentafluoropropane may be adjusted to 53% or less. Here, the amount of gas mixture dissolved in acrylic resin is 2.4 mol/L. If the concentration of pentafluoropropane is set to 8% or more, the release force can be lower by 10% or more than that in the case where the concentration of pentafluoropropane is 0%. Here, the amount of gas mixture dissolved in acrylic resin is 0.36 mol/L.

An experiment was performed using a mask having a pattern with a line width of 25 nm. When the concentration of pentafluoropropane was set to 0%, around 10% pattern defects were found, whereas when the concentration of pentafluoropropane was set to 53%, no pattern defects were found.

More generalization of this result produced a finding indicating that a good pattern can be obtained when the following expression is satisfied:

0.36≦{S·C+D·(1−C)}≦<2.4 (Expression 1)

where the solubility of the readily-soluble gas in the resin is S mol/L, the solubility of the slightly-soluble gas in the resin is D mol/L, and the concentration of the readily-soluble gas is C, at 20° C. and a pressure of 1 atmosphere.

If {S·C+D·(1−C)} is less than 0.2, the effect of reducing the release force is small. If {S·C+D·(1−C)} exceeds 1.2, the surface roughness is large because an excessive amount of gas is dissolved in the resin.

For example, even when nitrogen (the amount of nitrogen dissolved in 1 mL of acrylic resin is about 0.088 mg, that is, about 0.00314 mol/L) is used instead of helium, an appropriate concentration can be determined from Expression 1. Using nitrogen has a cost advantage over using helium.

As described above, according to the present embodiment, it is possible not only to reduce the time for filling with resin or reduce pattern defects, but also to reduce the surface roughness of resin.

### Second Embodiment

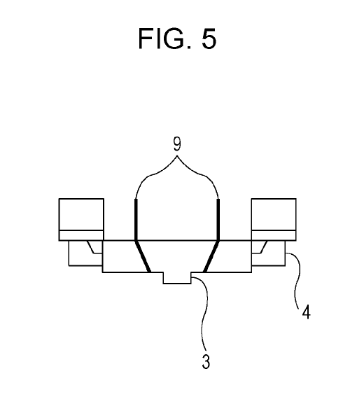

FIG. 5 illustrates an imprint apparatus according to a second embodiment. The imprint apparatus of the second embodiment differs from that of the first embodiment in the configuration of a supply port for supplying a gas mixture. The other configurations are the same as those in the first embodiment and the description thereof will be omitted.

In the present embodiment, the mold 3 is provided with a supply port for supplying a gas mixture. The mold 3 has a protruding portion, whose surface is provided with a micro-asperity pattern (pattern portion). The supply port is disposed around the protruding portion.

In the first embodiment, it takes several tens of milliseconds to bring a resin on a shot region and the mold 3 into contact with each other after the shot region passes under the gas supply unit 11. During this period of time, a readily-soluble gas once dissolved in the resin may come out of the resin. In particular, in the case of executing a positioning sequence after the shot region and the resin face each other, this period of time tends to become longer and the amount of readily-soluble gas coming out of the resin tends to increase.

The present embodiment allows the supply port to face the space between the mold 3 and the substrate 1. Thus, since the gas mixture can continue to be blown to the shot region until immediately before the resin on the shot region and the mold 3 are brought into contact with each other, it is possible to reduce the amount of readily-soluble gas coming out of the resin.

Gas mixture supply lines 9 of the present embodiment have a configuration similar to that of the gas mixture supply line 20 of the first embodiment, and are connected via the temperature control unit 36 to the readily-soluble gas supply line 33 and the slightly-soluble gas supply line 34.

In the present embodiment, there may be a supply port for supplying an inert gas and a discharge port for discharging a gas, as in the first embodiment.

### Third Embodiment

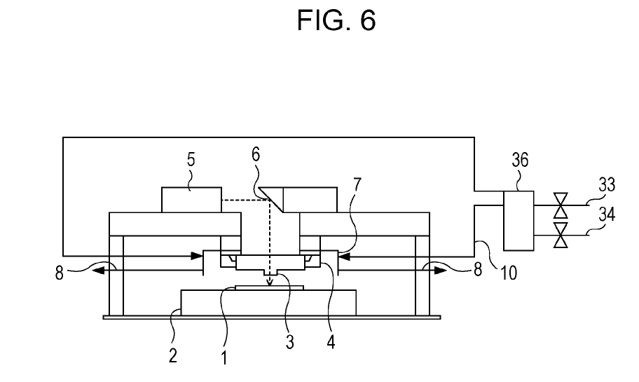

FIG. 6 illustrates an imprint apparatus according to a third embodiment. The imprint apparatus of the third embodiment differs from that of the first embodiment not only in the configuration of a supply port for supplying a gas mixture, but also in having no dispenser. The other configurations are the same as those in the first embodiment and the description thereof will be omitted.

In the present embodiment, a supply port 7 for supplying a gas mixture is defined by one division wall that surrounds the mold chuck 4. Gas mixture supply lines 10 and discharge lines 8 are connected to the supply port 7.

The gas mixture supply lines 10 of the present embodiment have a configuration similar to that of the gas mixture supply line 20 of the first embodiment, and are connected via the temperature control unit 36 to the readily-soluble gas supply line 33 and the slightly-soluble gas supply line 34.

In the present embodiment, there may be a supply port for supplying an inert gas, as in the first embodiment.

In the present embodiment, a resin is applied to the entire surface of the substrate before the substrate 1 is introduced into the imprint apparatus. Therefore, the imprint apparatus does not include the dispenser 12 for applying the resin.

### DEVICE MANUFACTURING METHOD

A method for manufacturing a device (semiconductor integrated circuit device, liquid crystal display device, etc.) includes a step of transferring (forming) a pattern on a substrate (e.g., wafer, glass plate, or film substrate) using the imprint apparatus described above. The method may further include a step of etching the substrate to which the pattern has been transferred. In the case of manufacturing another article, such as a patterned medium (recording medium) or an optical device, the method may include another processing step of processing the substrate to which the pattern has been transferred, instead of the etching step.

According to the invention of the present application, it is possible to provide an imprint method or an imprint apparatus that not only reduces the time for filling with resin or reduces pattern defects, but also reduces the surface roughness of resin.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An imprint method that brings a resin on a substrate and a mold having a pattern into contact with each other to transfer the pattern onto the substrate, the imprint method comprising:
a step of bringing the resin on the substrate and the mold into contact with each other while a space between the substrate and the mold is filled with a predetermined gas;
a step of curing the resin while the resin and the mold are in contact with each other; and
a step of separating the resin and the mold,
wherein the predetermined gas contains a first gas having a solubility of 0.36 mol/liter or more in the resin and a second gas having a solubility of less than 0.36 mol/liter in the resin, at 20° C. and a pressure of 1 atmosphere.

2. The imprint method according to claim 1, wherein the predetermined gas satisfies
0.36≦{S·C+D·(1−C)}≦2.4
where the solubility of the first gas in the resin is S mol/L, the solubility of the second gas in the resin is D mol/L, and a concentration of the first gas is C, at 20° C. and a pressure of 1 atmosphere.

3. The imprint method according to claim 1, further comprising a step of supplying a gas mixture obtained by mixing the first gas and the second gas.

4. The imprint method according to claim 1, wherein the second gas contains helium or nitrogen.

5. The imprint method according to claim 1, wherein the first gas contains pentafluoropropane.

6. An imprint apparatus that brings a resin on a substrate and a mold having a pattern into contact with each other to transfer the pattern onto the substrate, the imprint apparatus comprising:
a gas supply unit configured to supply a predetermined gas to the resin on the substrate;
a driving mechanism configured to bring the resin on the substrate and the mold into contact with each other; and
curing means for curing the resin while the resin and the mold are in contact with each other,
wherein the predetermined gas contains a first gas having a solubility of 0.36 mol/liter or more in the resin and a second gas having a solubility of less than 0.36 mol/liter in the resin, at 20° C. and a pressure of 1 atmosphere.
